(19) United States
(12) Patent Application Publication
(10) Pub. No.: US 2021/0297540 A1
(43) Pub. Date: Sep. 23, 2021

(54) IMAGE PROCESSING APPARATUS, IMAGE PROCESSING SYSTEM, AND METHOD PERFORMED THEREBY

(71) Applicant: TOSHIBA TEC KABUSHIKI KAISHA, Tokyo (JP)

(72) Inventor: Katsunori SUZUKI, Mishima Shizuoka (JP)

(21) Appl. No.: 16/824,615

(22) Filed: Mar. 19, 2020

(51) Int. Cl. H04N 1/00; H04W 8/00; H04W 48/10

(52) U.S. Cl. CPC H04N 1/00474; H04N 1/0048; H04N 1/00413; H04W 48/10; H04W 8/005

(57) ABSTRACT

An image processing apparatus includes a printing unit, a network interface, a memory, and a processor that, in response to a request for performing a printer function received from an external device via the network interface, controls the printing unit to perform the function. The memory stores a plurality of images each corresponding to an optional component attachable to the image processing apparatus. Upon receipt of a request for apparatus information from the external device via the network interface, the processor retrieves one or more of the images representing the components currently attached to the image processing apparatus, combines the retrieved images to form a representative image of the image processing apparatus, and controls the network interface to transmit the representative image to the external device.

### FIELD

Embodiments described herein related generally to an image processing apparatus, an image processing system, and a method performed thereby.

### BACKGROUND

In recent years, a technology for enabling access to functions of an MFP (Multi-Function Peripheral) from wireless terminals, such as smartphones, has been developed due to the widespread use of wireless terminals. With such a technology, a user can, for example, transmit data to be printed from a wireless terminal directly to an MFP for printing. In such a case, the wireless terminal may display a list of MFPs to which the wireless terminal can be wirelessly connected to directly to allow the user to select one of the MFPs from the list for printing. The wireless terminal transmits data (referred to as “print data” in this context) to the selected MFP and instructs the printing of the transmitted data (print data).

However, there are cases where insufficient information is presented to the user of the wireless terminal to permit the user to select an appropriate MFP from the listed MFPs. Therefore, in some instances, the user may select an inappropriate or incorrect MFP from among the listed MFPs for printing.

### BRIEF DESCRIPTION OF THE DRAWINGS

FIG. 1 is a schematic diagram showing an MFP system according to a first embodiment.

FIG. 2 is a diagram illustrating a list screen displayed on a wireless terminal in a conventional MFP system.

FIG. 3 is a diagram showing a configuration of the MFP in the first embodiment.

FIG. 4 is a diagram illustrating a configuration of a wireless terminal according to the first embodiment.

FIG. 5 is a sequence diagram of processing performed by a wireless terminal that displays a list screen of MFPs in the MFP system according to the first embodiment.

FIG. 6 is a diagram showing optional components that can be added to the MFP in the first embodiment.

FIGS. 7A-7C are diagrams illustrating option configurations of MFPs having the optional components according to the first embodiment.

FIG. 8 depicts a table of first setting information relating to the option configurations of various MFPs in the first embodiment.

FIG. 9 is a diagram illustrating a list screen displayed on the wireless terminal in the MFP system of the first embodiment.

FIG. 10 is a diagram showing an icon represented by a combination of an image showing the appearance of MFP and a color correspondence display in the first embodiment.

FIG. 11 is a diagram illustrating third setting information in a second embodiment.

FIG. 12 is a diagram illustrating the third setting information in the second embodiment.

FIG. 13 is a diagram illustrating a list screen displayed on a wireless terminal in an MFP system of the second embodiment.

### DETAILED DESCRIPTION

In one embodiment, an image processing apparatus includes a printing unit, a network interface, a memory, and a processor configured to, in response to a request for performing a function received from an external device via the network interface, control the printing unit to perform the function. The memory stores a plurality of images each indicating an optional component attachable to the image processing apparatus. Upon receipt of a request for apparatus information from the external device via the network interface, the processor retrieves one or more of the images corresponding to the optional component(s) attached to the image processing apparatus, combines the retrieved images to form a representative image of the image processing apparatus, and controls the network interface to transmit the representative image to the external device.

### First Embodiment

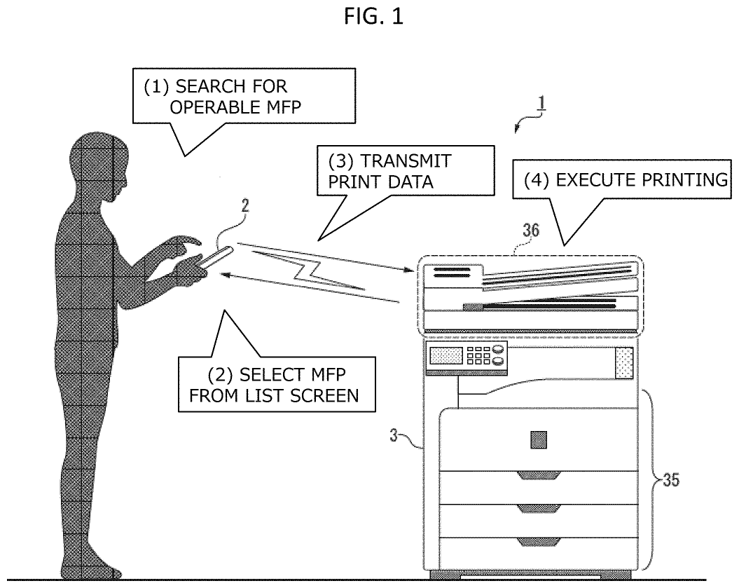

FIG. 1 is a schematic diagram showing an MFP system 1 in a first embodiment. The MFP system 1 is a system that enables various functions of an MFP 3 to be available from a wireless terminal 2. For example, the wireless terminal 2 is an information communication terminal having a wireless communication function, such as a smartphone or a tablet. The wireless terminal 2 and the MFP 3 are configured to be able to communicate with each other. For example, the wireless terminal 2 is installed with an application that makes the functions of the MFP 3 available via wireless communication (hereinafter referred to as “MFP application”). The user can remotely use various functions of the MFP 3 (hereinafter referred to as “MFP functions”) by operating the MFP application. For example, the MFP functions include a printer function, a scanner function, a copy function, a fax function, and the like.

As one example of such MFP functions, the MFP system 1 in which the printer function of the MFP 3 is made available from the wireless terminal 2 is shown in FIG. 1. In this case, (1) the user first searches for MFPs 3 available from the wireless terminal 2 by operating the MFP application on the wireless terminal 2. The MFPs 3 discovered by this search are listed on the wireless terminal 2. Hereinafter, a screen on which the wireless terminal 2 displays a list of the MFPs 3 is referred to as a “list screen”. Then, (2) the user selects one of the listed MFPs 3 to be used. As a result, (3) the print data is transmitted from the wireless terminal 2 to the selected MFP 3. Then, (4) the MFP 3 executes the printing process based on the print data received from the wireless terminal 2.

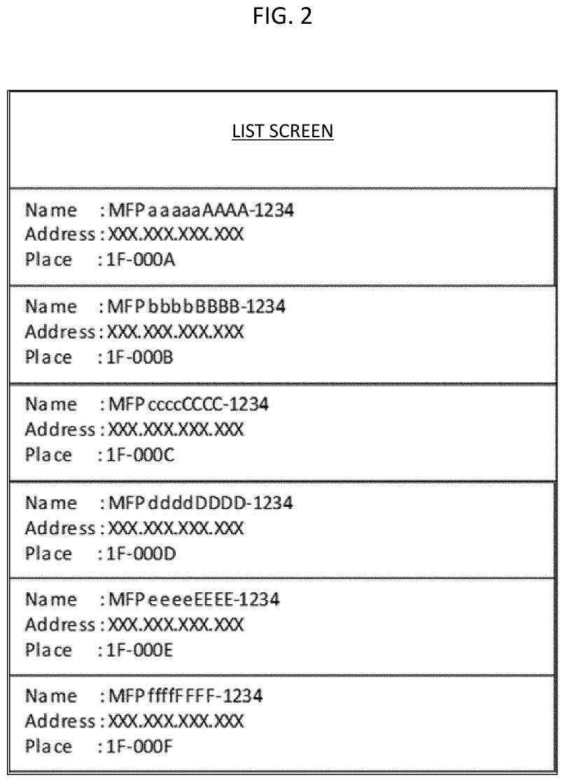

FIG. 2 is a diagram illustrating a list screen displayed on a wireless terminal in a conventional MFP system. For example, FIG. 2 shows a list screen in which six different MFPs which were discovered by a search are displayed. Hereinafter, information about each MFP displayed on such a list screen will be referred to as “apparatus information”. The list screen shown in FIG. 2 includes names, addresses (e.g., an IP or network address), and places (e.g., room numbers) as apparatus information for each MFP. The user can instruct the selected MFP to execute the desired MFP function by selecting the MFP to be used from among the MFPs listed in this manner.

However, the user may not always accurately remember or memorize the apparatus information of the MFP that he or she wants to use. Therefore, it is generally difficult for a user to determine a desired MFP based only on the apparatus information illustrated in FIG. 2. Even if the apparatus information is correctly memorized, it still takes time and mental labor to identify the target apparatus information from among the many pieces of character information displayed in the list. As such, in the conventional display method of a list screen, the user may not always be able to properly select a desired MFP from among the listed MFPs.

The MFP system 1 of the first embodiment allows a user to appropriately select an MFP to be used from among the MFPs listed.

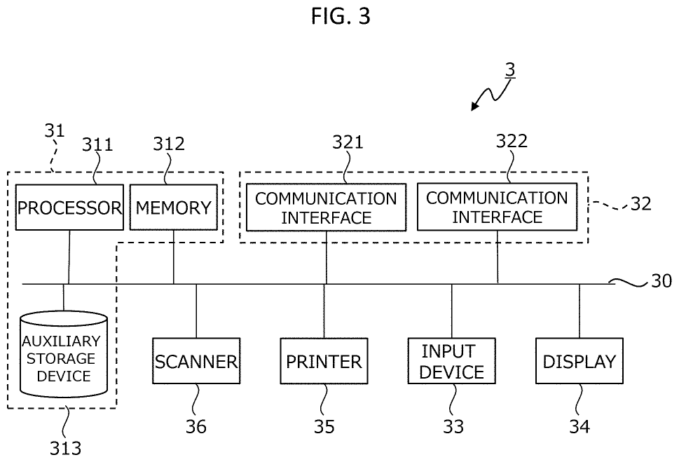

FIG. 3 is a diagram illustrating a configuration of the MFP 3 according to the first embodiment. For example, the MFP 3 includes a processor 311, a memory 312, an auxiliary storage device 313, a communication unit 32, an input device 33, a display 34, a printer 35, and a scanner 36, and a bus 30 for connecting them. The MFP 3 functions as an information processing apparatus that provides an MFP function by loading a program stored in the auxiliary storage device 313 into the memory 312 and executing the program by the processor 311. For example, the program described herein is a program such as BIOS (Basic Input Output System), OS (Operating system), or various firmware.

The processor 311, the memory 312, and the auxiliary storage device 313 are not limited to any specific type or types as long as they can operate to cause the MFP 3 to function as an information processing apparatus for providing the MFP function(s). For example, the processor 311 is a CPU (Central Processing Unit). The processor 311 may also include a Graphics Processing Unit (GPU). Further, for example, the memory 312 is a random access memory (RAM). The memory 312 may also include a read only memory (ROM). The auxiliary storage device 313 is a storage device such as a magnetic hard disk device or a semiconductor storage device (also referred to as a solid-state storage device).

All or a part of the functions of the MFP 3 may be performed by hardware such as an ASIC (Application Specific Integrated Circuit), a PLD (Programmable Logic Device), or an FPGA (Field Programmable Gate Array). The program executed may be recorded on a computer-readable, non-transitory recording medium. The computer-readable recording medium is, for example, a flexible disk, a magneto-optical disk, a portable medium such as a ROM, a CD-ROM, or the like, a storage device such as a hard disk incorporated in a computer system, or the like. The program may be transmitted over a telecommunications line in some examples.

As described above, the processor 311, the memory 312, and the auxiliary storage device 313 together function to serve as a controller for allowing the MFP 3 to provide MFP functions. Therefore, in the following description, the processor 311, the memory 312, and the auxiliary storage device 313 are sometimes collectively referred to as “controller 31.” The controller 31 has a function of transmitting the apparatus information of its own apparatus to the wireless terminal 2 in response to the request of the wireless terminal 2. The controller 31 has a function of executing the designated MFP function in response to a request from the wireless terminal 2. The controller 31 stores various setting information necessary for performing these functions in the auxiliary storage device 313.

The configuration of the controller 31 is not limited to a specific configuration as long as it can cause the MFP 3 to provide the MFP functions by executing the program.

The auxiliary storage device 313 stores various pieces of setting information necessary for realizing functions of the controller 31. More specifically, the auxiliary storage device 313 stores information necessary for the controller 31 to generate apparatus information of its own device as setting information.

The communication unit 32 is a communication interface configured to connect the MFP 3 and the wireless terminal 2 to communicate with each other. Here, the communication unit 32 includes a wireless communication interface circuit 321 and a wired communication interface circuit 322. As a result, the MFP 3 can directly or indirectly communicate with the wireless terminal 2.

The input device 33 is an input device, such as a touch panel, a mouse, and a keyboard. The input device 33 receives input of various operations to the MFP 3, and outputs the input information to the processor 311. The processor 311 executes processing according to the input information, whereby various MFP functions are executed in the MFP 3.

The display 34 is a display device such as a CRT (Cathode Ray Tube) display, a liquid crystal display, an organic EL (Electro-Luminescence) display, or the like. The display 34 displays various kinds of information related to the operation of the MFP 3. For example, information to be displayed by the display 34 is output from the processor 311.

The printer 35 can form an image on a sheet based on scan data generated by the scanner 36 or scan data received via a communication path. For example, the printer 35 includes an image forming unit for forming a desired image on a sheet, a sheet accommodating unit for storing sheets, and the like. The image forming unit forms an electrostatic latent image on a photosensitive drum according to the generated or received scan data, and the electrostatic latent image is developed by using a developer, then the developed image is transferred to a sheet. The developer is, for example, a toner. The toner may be a decolorable toner which can be decolorized at or above a predetermined temperature. The image forming unit fixes the developed image (e.g., toner image) to the sheet by heating and pressing the sheet in a fixing unit. The sheets that are printed may be a sheet storage in a sheet accommodating unit or a sheet that has been manually inserted.

In response to the instruction from the controller 31, the scanner 36 reads the appearance of a read object as light and dark signals. For example, the scanner 36 scans the object to be read by using an image sensor such as a CCD (Charge coupled device) or a CIS (contact image sensor). The scanner 36 outputs the scanned data to the controller 31.

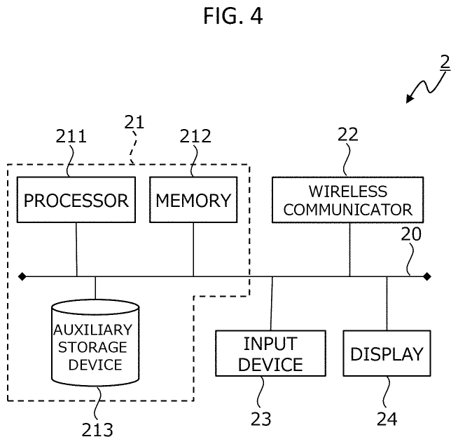

FIG. 4 is a diagram illustrating a configuration of the wireless terminal 2 according to the first embodiment. For example, the wireless terminal 2 includes a processor 211, a memory 212, an auxiliary storage device 213, a wireless communicator 22, an input device 23, and a display 24, and a bus 20 connecting them. The wireless terminal 2 functions as an information processing apparatus having a wireless communication function by loading a program stored in the auxiliary storage device 213 onto the memory 212 and executing the program by the processor 211. For example, the program referred to herein is a program such as BIOS, OS, or various firmware.

In general, the processor 211, the memory 212, and the auxiliary storage device 213 are not limited to any specific types as long as together they can cause the wireless terminal 2 to function as an information processing apparatus having a wireless communication function. For example, the processor 211 may be a CPU. The processor 211 may include a GPU. Further, for example, the memory 212 is a RAM. The memory 212 may include a ROM. The auxiliary storage device 213 is a storage device such as a magnetic hard disk device or a semiconductor storage device.

All or part of the functions of the wireless terminal 2 may be performed by hardware, such as an ASIC, a PLD, an FPGA, or the like. The program may be recorded on a computer-readable, non-transitory recording medium. The computer-readable recording medium is, for example, a flexible disk, a magneto-optical disk, a portable medium such as a ROM, a CD-ROM, or the like, a storage device such as a hard disk incorporated in a computer system, or the like. The program may be transmitted over a telecommunications line.

The processor 211, the memory 212, and the auxiliary storage device 213 together function as a controller for causing the wireless terminal 2 to function as an information processing apparatus having wireless communication functions. Therefore, in the following description, the processor 211, the memory 212, and the auxiliary storage device 213 in some instances may be collectively referred to as “controller 21.” The controller 21 executes the MFP application and thus has a function of instructing the MFP 3 to execute an MFP function.

Specifically, the controller 21 also has a function of searching for MFPs 3 that can be used in accordance with the user's input operation, and acquiring the apparatus information from each of the MFPs 3 that have been discovered in the searching. The controller 21 has a function of generating a list screen indicating the available MFPs 3 based on the apparatus information acquired from the discovered MFPs 3. The controller 21 also has a function to display the generated list screen on the display 34, and to then instruct the MFP 3 selected from the list screen to execute the designated MFP function.

The wireless communicator 22 is a wireless communication interface configured to connect the wireless terminal 2 and the MFP 3 to communicate with each other. For example, the wireless communication interface is a communication interface that connects to a mobile phone network such as a third generation (3G) or a fourth generation (4G) wireless network. Also, for example, the wireless communication interface may be a wireless LAN communication interface such as Wi-Fi®.

The input device 23 is an input device, such as a touch panel, a mouse, and a keyboard. The input device 23 receives input of various operations to the wireless terminal 2, and outputs input information to the processor 211. The processor 211 instructs the MFP application to execute processing corresponding to the input information, thereby instructing the MFP 3 to execute various MFP functions.

The display 24 is a display device such as a CRT display, a liquid crystal display, or an organic EL display. The display 24 displays various information related to the operation of the wireless terminal 2. For example, an operation screen of the MFP application is displayed on the display 24. Further, the information to be displayed on the display 24 is output from the processor 211.

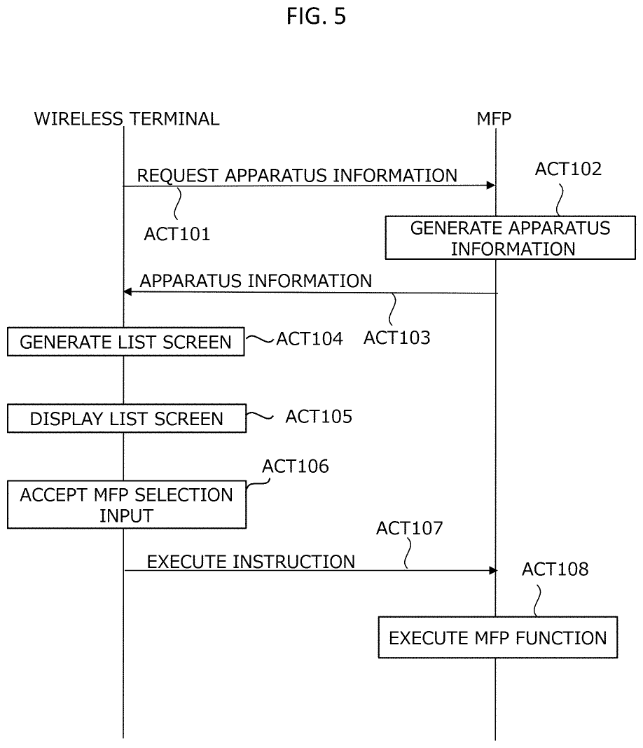

FIG. 5 is a sequence diagram showing a process performed by the wireless terminal 2 that displays a list screen of MFPs 3 in the MFP system 1 of the first embodiment. At the beginning of the processing shown in FIG. 4, the MFP application is executed by the wireless terminal 2. In this state, the MFP application waits for an input of an operation for selecting one MFP function from among a plurality of MFP functions.

In this state, the user inputs an operation for selecting an MFP function to be used for the MFP application. The controller 21 of the wireless terminal 2 performs processing for searching for MFPs 3 available in response to the input of the operation. Specifically, the controller 21 broadcasts a response request for apparatus information over a network (ACT 101, apparatus information request). The apparatus information request is received by each of the MFPs 3 connected to the network.

Subsequently, in each of the MFPs 3, the controller 31 generates the apparatus information to be transmitted to the wireless terminal 2 in response to the apparatus information request (ACT 102). Specifically, the controller 31 generates the apparatus information including an image which schematically shows the appearance of the MFP 3 (hereinafter, referred to as an “icon”) in addition to the conventional character information (hereinafter referred to as “basic information”) shown in the example of FIG. 2. The controller 31 transmits the generated apparatus information to the wireless terminal 2 that is the source of the request (ACT 103). The controller 31 may send information indicating the storage location of the icon data instead of specifically transmitting the image data of the icon itself (hereinafter referred to as “icon data”). For example, the controller 31 may provide a URI (Uniform Resource Identifier), URL (Uniform Resource Locator), or the like for indicating the storage location of the icon data. In this case, the wireless terminal 2 will acquire the icon data by accessing the provided URI or URL. But any event, the wireless terminal 2 receives the apparatus information according to a transmission from the MFP 3.

In addition, in some examples, each MFP 3 may store icon data, which schematically indicates its characteristics by appearance in the auxiliary storage device 313. Each MFP 3 may also be configured to generate such icon data in response to a request from the wireless terminal 2.

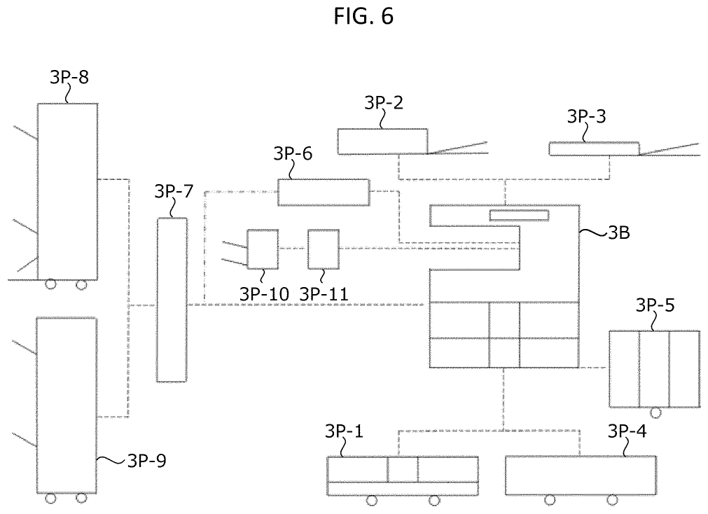

FIG. 6 to FIG. 8 are diagrams showing a method for the MFP 3 to generate icon data in the MFP system 1 according to the first embodiment. In general, the function of the MFP can be extended by adding components. Hereinafter, the component for extension of the function will be referred to as “option”. Addition of options affects the appearance of the MFP. Therefore, in the MFP system 1 of the present embodiment, each MFP 3 generates icon data corresponding to its respective option configurations and supplies the icon data to the wireless terminal 2 to indicate the presence of available options. Thus, the wireless terminal 2 can list the basic information of each MFP 3 together with an icon reflecting the respective option configurations of each individual MFP 3. Therefore, the user can more easily identify the desired MFP 3 from the list screen.

FIG. 6 is a diagram showing various options that can be added to an MFP 3. For example, FIG. 6 shows as possible options: a paper feeder 3P-1, a first auto document feeder (ADF) 3P-2, a second ADF 3P-3, a desk attachment 3P-4, an external large capacity feeder (LCF) 3P-5, a bridge kit 3P-6, a hole punch unit 3P-7, a saddle stitch finisher 3P-8, a staple finisher 3P- 9, an inner finisher 3P-10, and an inner hole punch unit 3P-11. These various units are some examples of options that can be added to the basic casing 3B of the MFP 3.

For example, the correspondence between the above-recited options and the image representing the appearance of each of the options can be stored as first setting information in each of MFPs 3. In addition, second setting information indicating the option configuration of the apparatus itself can be stored in each of MFPs 3. Furthermore, an image depicting the basic casing of the MFP 3 and the image data of its respective options can be stored in each of the MFPs 3. Accordingly, a controller 31 can generate icon data by combining image data corresponding to the option configuration of the apparatus with the image data of the basic casing of the apparatus. Hereinafter, the image data representing an optional appearance or configuration is referred to as “option image data”, and an image formed by the option image data is referred to as an “option image”.

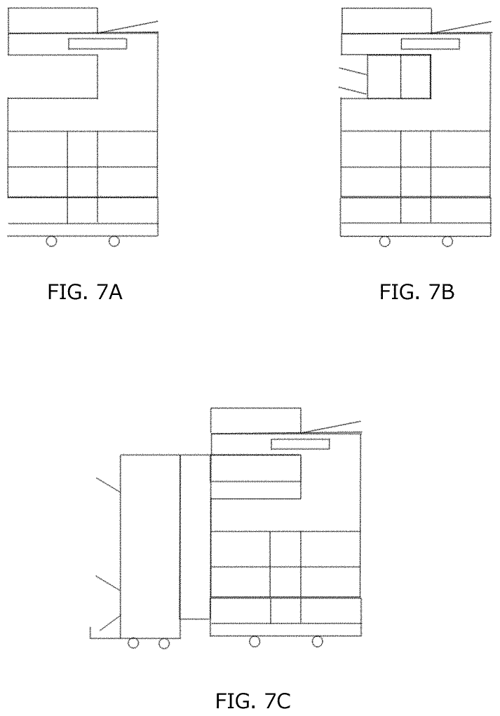

FIGS. 7A-7C show examples of an option configuration of an MFP 3. For example, FIG. 7A shows a configuration in which the paper feeder 3P-1 and the ADF 3P-2 are attached to the basic casing 3B. Further, for example, FIG. 7B shows a configuration in which a paper feeder 3P-1, an ADF 3P-2, an inner finisher 3P-10, and an inner hole punch unit 3P-11 are attached to the basic casing 3B. FIG. 7C shows a structure in which a paper feeder 3P-1, an ADF 3P-2, a bridge kit 3P-6, a hole punch unit 3P-7, and a saddle stitch finisher 3P-8 are attached to the base casing 3B.

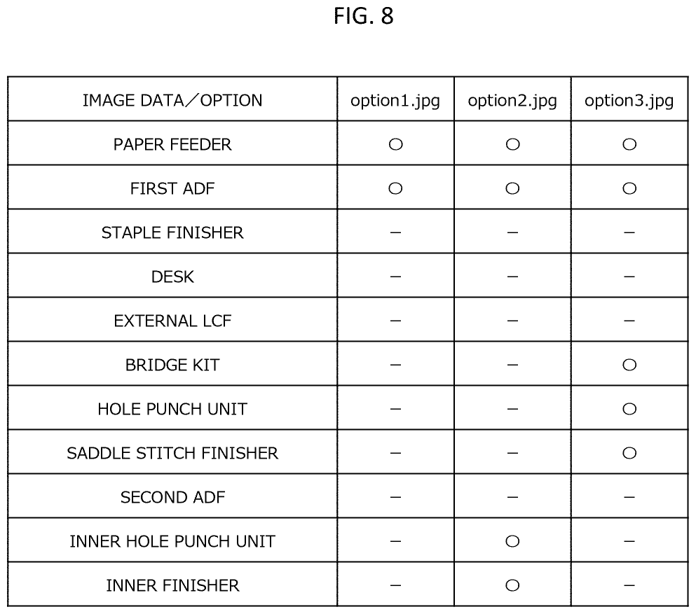

FIG. 8 depicts a table in which the first setting information relating to possible option configurations. For example, “option 1.jpg” in this example represents the option image data corresponding to the configuration of FIG. 7A. Specifically, “option 1.jpg” represents the appearance of the paper feeder 3P-1 and the ADF 3P-2. Similarly, in this example, “option 2.jpg” represents option image data corresponding to the configuration of FIG. 7B, and “option 3.jpg” represents option image data corresponding to the configuration of FIG. 7C. In this case, for example, the controller 31 can generate icon data corresponding to the configuration of FIG. 7A by combining “option 1.jpg” with the image data of the basic casing 3B. Similarly, for example, the controller 31 may generate icon data corresponding to the configuration of FIG. 7B or FIG. 7C by combining “option 2.jpg” or “option 3.jpg” with the image data of the basic casing 3B.

In FIG. 8, two or more optional appearance features can be represented in just one combined option image data. However, in some examples, the option image data may be prepared as image data representing characteristics of the appearance for each individual options. Even in such a case, the controller 31 can generate icon data by combining one or more option image data with the image data of the basic casing 3B.

Returning to the description of FIG. 5, following ACT 103, at the wireless terminal 2, the controller 21 generates the apparatus information screen of the MFPs 3 that are available based on the apparatus information acquired from the MFPs 3 (ACT 104). The controller 21 displays the generated list screen on the display 25 (ACT 105). The controller 21 accepts input of an operation of selecting one of the MFPs 3 displayed on the list screen (ACT 106). The controller 21 instructs the selected MFP 3 to execute the MFP function specified by the user (ACT 107, execution instruction). In response to the execution instruction, the MFP 3 executes the designated MFP function (ACT 108), and reports the execution result to the wireless terminal 2 as necessary.

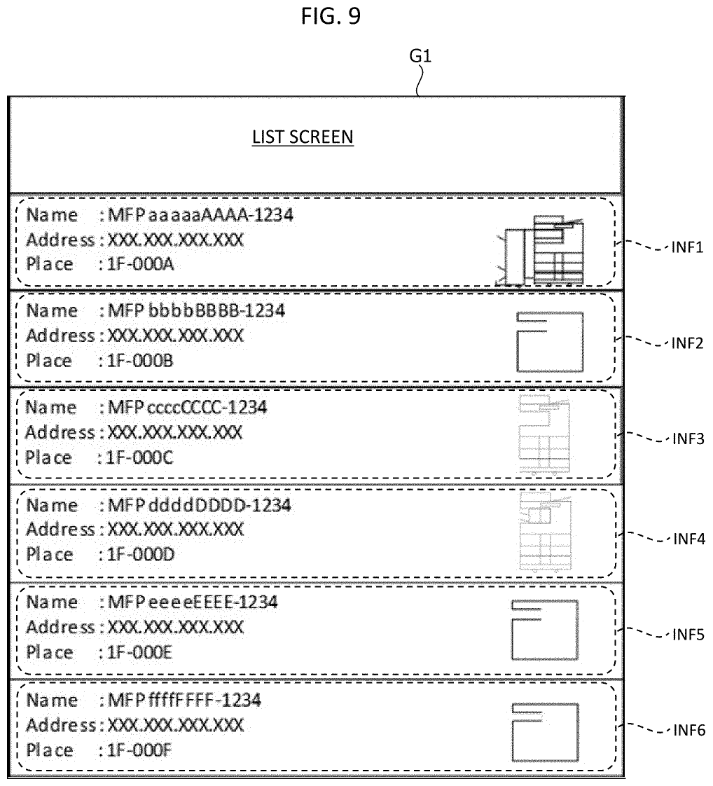

FIG. 9 is a diagram illustrating a list screen displayed on the wireless terminal 2 in the MFP system 1 according to the first embodiment. For example, a search result similar to that of the list screen illustrated in FIG. 2 is obtained in the MFP system 1 of the present embodiment. In this case, the controller 21 of the wireless terminal 2 causes the list screen G1 shown in FIG. 9 to be displayed, for example. The list screen G1 differs from the conventional list screen in that the icon of each MFP 3 is displayed in association with the basic information shown on the conventional list screen. The icons that schematically show the appearance characteristics of the MFPs 3 are displayed in association with the basic information of the MFPs 3, so that the user can easily identify the desired MFP 3.

For example, according to FIG. 9, the user can easily visually judge that the MFP 3 shown in the apparatus information INF1 is provided with the paper feeder 3P-1, the ADF 3P-2, the bridge kit 3P-6, the hole punch unit 3P-7, and the saddle stitch finisher 3P-8.

Moreover, for example, the user can easily judge that the MFP 3 shown in the apparatus information INF3 is provided with the paper feeder 3P-1 and the ADF 3P-2.

Further, for example, the user can easily visually determine that the MFP 3 shown in the apparatus information INF4 is provided with the paper feeder 3P-1, the ADF 3P-2, the inner finisher 3P-10, and the inner hole punch unit 3P-11.

Also, for example, the user can easily determine that the MFPs 3 shown in the apparatus information INF2, INF5 and INF6 do not have any optional component.

By facilitating the identification of the MFP 3, the user can appropriately select the desired MFP 3 from the list screen based on the actual image of the MFP 3 that is desired to be used by the user.

### First Modification Example

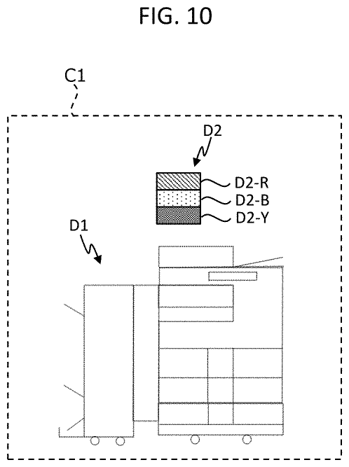

In the first embodiment, the basic information of each MFP 3 and icons schematically indicating the characteristics of the appearance of each MFP 3 are displayed as the apparatus information of the MFPs 3 discovered by the search. In this case, the controller 31 of the MFP 3 may be configured to generate an icon further indicating information other than the just the external apparatus appearance of the MFP 1. For example, the controller 31 may generate an icon indicating that color printing can be performed (hereinafter, referred to as “color correspondence display”) by the represented MFP 3. FIG. 10 shows a modification example of the icon C1 represented by the combination of the image D1 (indicating the appearance of the MFP 3) and the image D2 (indicating that color printing can be performed). Although the icon D2 is represented by the combination of the rectangles D2-R, D2-B and D2-Y displaying the respective colors of red, blue and yellow here, the icon may be instead represented in other aspects and the depicted image D2 is merely one possible example.

### Second Modification Example

In the first embodiment, the MFP 3 generates icon data corresponding to its option configuration and then supplies the icon data to the wireless terminal 2. However, the generation of icon data does not necessarily have to be performed by the MFP 3. For example, the wireless terminal 2 may be configured to generate icon data when the wireless terminal 2 acquires the information necessary to generate icon data. For example, it is possible to store image data indicating the basic configuration of the MFP 3 along with option image data for each of the various possible options in the wireless terminal 2. In this case, each listed MFP 3 may be displayed with identifying image data combined from those stored on the wireless terminal 2 based on the first setting information and the second setting information received by the wireless terminal 2.

### Second Embodiment

An MFP system 1 of a second embodiment is different from the MFP system 1 of the first embodiment in that the wireless terminal 2 is capable of displaying various attribute information for each MFP 3 as the apparatus information of the MFP 3 in addition to an icon for each MFP 3. Here, the attribute information is information related to the MFP 3, and may be any information that is not easily represented by basic configuration information or icons related to external appearance.

The wireless terminal 2 in the second embodiment is the same as the controller 21 in the first embodiment except that part of the configuration of the controller 21 is different from that in the first embodiment. In the MFPs 3 in the second embodiment, a part of the configuration of the controller 31 is different from that in the first embodiment, however the rest of the configuration is the same as that in the first embodiment. Therefore, in the second embodiment, the configurations of the wireless terminal 2 and the MFP 3 are substantially the same as those depicted in FIG. 3 and FIG. 4.

In the second embodiment, the controller 31 of the MFP 3 stores third setting information defining attribute information in the auxiliary storage device 313 to be displayed. In response to the request of the wireless terminal 2, the controller 31 transmits the basic information of the MFP apparatus and an icon, in addition to the attribute information for the MFP apparatus, in response to a request from the wireless terminal 2. The controller 21 of the wireless terminal 2 displays the basic information for each discovered MFP 3 in a list screen in association with the respective icons and the attribute information.

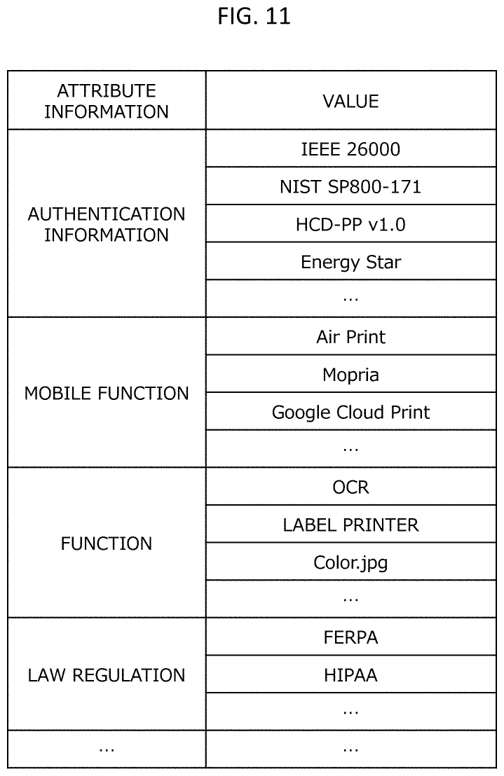

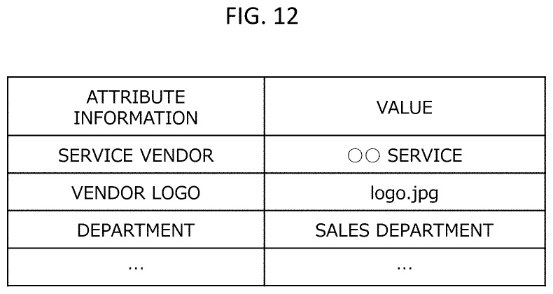

FIGS. 11 and 12 are diagrams showing the third setting information in the second embodiment. As described above, the attribute information may be any information. For example, the third setting information shown in FIG. 11 defines product specifications of the MFP 3 as attribute information. When such attribute information is displayed in the list screen, the user can more easily identify the MFP 3 conforming to his or her preferences from among the listed MFPs 3. For example, the user can easily identify the MFP 3 that has received a specific type of product authentication, such as IEEE 36000 and NIST SP800-171, from among the listed MFPs 3. Further, for example, the user can easily identify an MFP 3 corresponding to a specific desirable function for the user, such as Air Print and Google Cloud Print, from among the listed MFPs 3. Further, for example, the user can easily identify an MFP 3 designed to operate according to a specific law, such as FERPA (Family Educational Rights and Privacy Act) and HIPAA (Health Insurance Portability and Accountability Act), from among the listed MFPs 3.

Further, for example, the third setting information shown in FIG. 12 defines, as attribute information, information relating to the operation of an MFP 3, such as vendor or management information. By displaying such attribute information in the list screen, the user can easily identify an MFP 3 that can be used by itself from among the MFPs 3 listed in the list.

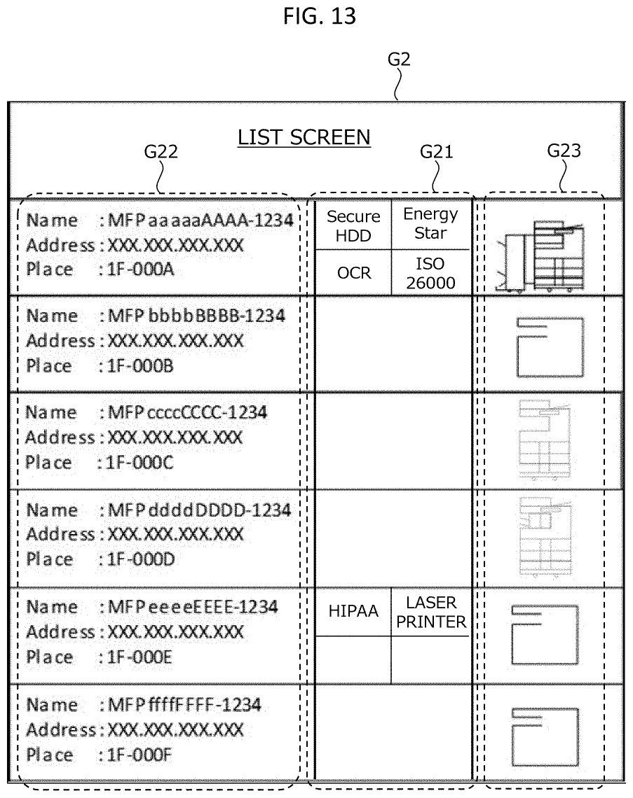

FIG. 13 is a diagram illustrating a list screen displayed on the wireless terminal 2 in the MFP system 1 according to the second embodiment. In the list screen G2 shown in FIG. 13, the display area of the attribute information G21 is added to the list screen G1 illustrated in FIG. 9. FIG. 13 shows an example in which a display area of attribute information G21 is arranged between the display area of the basic information G22 and the display area of the icon G23. In other examples, the basic information, the attribute information, and the icon display areas may be arranged in a layout different from that shown in FIG. 13. For example, the display area of the icon G23 may be arranged between the display area of the basic information G22 and the display area of the attribute information G21.

Moreover, as long as the attribute information and the icon are displayable in association with each other in some manner, they do not necessarily have to be displayed at the same time. For example, the controller 21 may configure the list screen so that the display of the attribute information and the display of the icon are switched in response to a predetermined input operation, e.g. pressing of a button or the like.

Moreover, it is not always necessary for all of the attribute information items to be displayed simultaneously with respect to an MFP 3. For example, when the attribute information is displayed in the layout as in the example shown in FIG. 13, it is not always possible to display five or more pieces of attribute information at the same time. In such a case, the display area may be divided into five or more pieces, and all pieces of attribute information may be displayed by reducing the occupied display area per piece of information, but if the pieces are too small, the visibility of the information may deteriorate. In such a case, for example, the controller 21 may configure the list screen so that the display of attribute information is switched in response to a predetermined input operation (for example, a scrolling or the like).

The switching of the display does not necessarily have to be performed in accordance with the user's operation. For example, the switching of the display may be performed every time a predetermined time elapses.

Thus, the attribute information of each MFP 3 can be displayed in association with the basic information, so that the user can more easily identify the MFP 3 that conforms to his or her preferences from among the MFPs 3 that are listed.

### Modification Example

Among the MFP functions, the wireless terminal 2 and the MFP 3 may communicate with each other by a dedicated communication protocol (hereinafter referred to as a “dedicated protocol”). In such a case, the wireless terminal 2 may acquire information specific to the MFP function from the MFP 3 by communication based on the dedicated protocol. Therefore, the wireless terminal 2 may acquire part or all of the apparatus information to be displayed in the list screen by communication based on a dedicated protocol with the MFP 3.

The icon in the aforementioned embodiments is an example of information corresponding to the appearance of the MFP 3. In addition, the attribute information in the embodiments is an example of information corresponding to a feature or device aspect that might not be obvious from the external appearance of the MFP.

“Decolorization” or “decolorable” as used in the present disclosure refers to a specialized toner or ink that can initially be any color (e.g., white, black, red, blue, green, etc.) different from the color of a sheet on which printing is being performed, but which becomes the color (or substantially so) of the sheet or otherwise transparent (or substantially so) upon heating above a threshold temperature or the like.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The embodiments and variations thereof are included within the scope and spirit of the invention as well as the scope of the appended claims.

What is claimed:

1. An image processing apparatus, comprising:
a printing unit;
a network interface;
a memory; and
a processor configured to control the printing unit to perform a function in response to a request for performing the function received from an external device via the network interface, wherein
the memory stores a plurality of images corresponding to optional components attached to the image processing apparatus, and
the processor is further configured to:
upon receipt of a request for apparatus information from the external device via the network interface, retrieve one or more of the images corresponding to the optional components attached to the image processing apparatus,
combine the retrieved images to form a representative image corresponding to the image processing apparatus, and
control the network interface to transmit the representative image to the external device.

2. The image processing apparatus according to claim 1, wherein
the plurality of images stored in the memory includes an image of a hole punch unit, a finisher, a bridge kit, a paper feeder, or an automated document feeder.

3. The image processing apparatus according to claim 2, wherein
the retrieved images are combined with an image representing a body of the image processing apparatus.

4. The image processing apparatus according to claim 1, wherein
the processor is configured to generate text information indicating one or more attributes of the image processing apparatus upon receipt of the request for apparatus information.

5. The image processing apparatus according to claim 4, wherein
said one or more attributes include a name, an IP address, or a location of the image processing apparatus.

6. The image processing apparatus according to claim 4, wherein
said one or more attributes includes:
a name of a standard or a law to which the image processing apparatus is designed to conform, and
a function supported by the image processing apparatus.

7. The image processing apparatus according to claim 1, wherein
the processor is configured to combine an image indicating that color printing is supported into the representative image.

8. The image processing apparatus according to claim 1, wherein
the processor is configured to transmit, to the external device, a link to an image corresponding to each of one or more optional components attached to the image processing apparatus.

9. The image processing apparatus according to claim 1, wherein
the processor is configured to control the network interface to transmit identification information that identifies one or more optional components currently attached to the image processing apparatus upon receipt of the request for apparatus information from the external device.

10. The image processing apparatus according to claim 1, wherein
the request for apparatus information is broadcast by the external device.

11. An image processing system comprising:
a user terminal including:
a first network interface, and
a first processor configured to control the first network interface to issue a request for performing a function upon receipt of a user input requesting the function; and
a plurality of image processing apparatuses each including:
a printing unit;
a second network interface;
a memory; and
a second processor configured to control the printing unit to perform the function in response to the request from the user terminal,
wherein the memory of each of the image processing apparatuses respectively stores a plurality of images corresponding to optional components attached to the image processing apparatus,
the first processor is further configured to control the first network interface to transmit a request for apparatus information to the plurality of image processing apparatuses, and
the second processor of each of the image processing apparatuses is further configured to:
retrieve one or more of the images corresponding to the optional components attached to the image processing apparatus,
combine the retrieved images to form a representative image corresponding to the image processing apparatus, and
control the second network interface to transmit the representative image to the user terminal.

12. The image processing system according to claim 11, wherein
the user terminal includes a display, and
the first processor is configured to generate a screen for the display presenting a list of the image processing apparatuses in conjunction with the received representative images.

13. The image processing system according to claim 12, wherein
the first processor is configured to control the first network interface to transmit the request for performing the function to the image processing apparatus selected by the user from the list.

14. The image processing system according to claim 11, wherein
the plurality of images stored in the memory includes an image a hole punch unit, a finisher, a bridge kit, a paper feeder, or an automated document feeder.

15. The image processing system according to claim 14, wherein
the retrieved images are combined with an image representing a body of the image processing apparatus.

16. The image processing system according to claim 11, wherein
the second processor of each of the image processing apparatuses is configured to generate text information indicating one or more attributes of the image processing apparatus upon receipt of the request for apparatus information.

17. The image processing system according to claim 16, wherein p1 said one or more attributes include a name, an IP address, or a location of the image processing apparatus.

18. The image processing system according to claim 16, wherein
said one or more attributes includes:
a name of a standard or a law to which the image processing apparatus is designed to confirm, and
a printing function supported by the image processing apparatus.

19. The image processing system according to claim 16, wherein
the text information is displayed together with the representative image on the screen.

20. A method performed by an image processing system including a user terminal and a plurality of image processing apparatuses, the method comprising:
storing in each of the image processing apparatuses a plurality of images each corresponding to an optionable component attached to the image processing apparatus;
upon receipt of a user input at the user terminal, transmitting a request for apparatus information from the user terminal to the plurality of image processing apparatuses; and
upon receipt of the request for apparatus information from the user terminal, each of the image processing apparatus:
retrieving one or more of the images corresponding to one or more optional components attached to the image processing apparatus,
combining the retrieved images to form a representative image of the image processing apparatus, and
transmitting the representative image to the user terminal.
